(19) United States
(12) Patent Application Publication
(10) Pub. No.: US 2026/0152197 A1
(43) Pub. Date: Jun. 4, 2026

(54) METHOD AND SYSTEM FOR CONTROLLING AN AUTONOMOUS VEHICLE

(71) Applicant: HYUNDAI AUTOEVER CORP., Seoul (KR)

(72) Inventor: Jong Gon Kim, Seoul (KR)

(73) Assignee: HYUNDAI AUTOEVER CORP., Seoul (KR)

(21) Appl. No.: 19/395,270

(22) Filed: Nov. 20, 2025

(30) Foreign Application Priority Data
Dec. 4, 2024 (KR) 10-2024-0178317

(51) Int. Cl. B60W 50/08; B60K 35/10; B60W 30/16

(52) U.S. Cl. CPC B60W 50/085; B60K 35/10; B60W 30/16; B60K 2360/119; B60K 2360/146

(57) ABSTRACT

A method for controlling an autonomous vehicle includes recognizing surrounding objects around the autonomous vehicle and displaying the surrounding objects on a display guiding an autonomous driving situation. The method also includes receiving a user gesture for adjusting an inter-vehicle spacing between the autonomous vehicle and a spacing-adjustment target object selected from the surrounding objects displayed on the display. The method additionally includes transmitting a control signal to the autonomous vehicle to control the autonomous vehicle to travel according to the adjusted inter-vehicle spacing.

### CROSS-REFERENCE TO RELATED APPLICATION

This application claims the benefit of and priority to Korean Patent Application No. 10-2024-0178317, filed on Dec. 4, 2024, the entire contents of which are hereby incorporated herein by reference.

### TECHNICAL FIELD

The present disclosure relates to a method and a system for controlling an autonomous vehicle.

### BACKGROUND

The statements in this section merely provide background information related to the present disclosure and may not constitute prior art.

A self-driving or autonomous vehicle refers to a vehicle that drives in a self-determining manner without human driver intervention. Specifically, the autonomous vehicle determines acceleration and deceleration, braking, a distance from a surrounding vehicle, a lane change, etc. by itself. The higher the technology level of an autonomous driving system, the less human driver interventions.

There is a problem in that an inter-vehicle spacing between the autonomous vehicle and a surrounding driving object may not be adjusted according to a type of the surrounding driving object in a current autonomous driving mode. In addition, the degree of risks between the surrounding driving objects and the inter-vehicle spacings for safety felt by different drivers may be different from each other.

### SUMMARY

Aspects of the present disclosure provide a technology that allows a driver to directly set an inter-vehicle spacing between an autonomous vehicle and a surrounding driving object around the autonomous vehicle.

The autonomous driving or the autonomous driving system according to embodiments of the present disclosure is a concept that includes all levels from ‘partial autonomous driving’ that requires partial manipulation by a human driver to ‘fully autonomous driving’ that does not require any manipulation by a human driver. In other words, the autonomous driving or the autonomous driving system according to embodiments of the present disclosure is a concept that includes all of the autonomous driving levels 1 to 5.

Aspects of the present disclosure provide a method and a system for controlling an autonomous vehicle that adjusts an inter-vehicle spacing between an autonomous vehicle and a surrounding driving object based on an input from a user using an autonomous driving system.

Aspects the present disclosure provide a method and a system for controlling an autonomous vehicle that guides an appropriate inter-vehicle spacing between an autonomous vehicle and a surrounding driving object to a user who uses an autonomous driving system.

Aspects of the present disclosure provide a method and system for controlling an autonomous vehicle that provides feedback on appropriateness of an inter-vehicle spacing between an autonomous vehicle and a surrounding driving object based on an input from a user using an autonomous driving system.

Aspects of the present disclosure provide a method and system for controlling an autonomous vehicle which changes a driving lane of an autonomous vehicle based on an input from a user using an autonomous driving system.

The technical purposes of the present disclosure are not limited to the technical purposes mentioned above. Other technical purposes not mentioned herein should be more clearly understood by those having ordinary skill in the art from the following description.

According to an aspect of the present disclosure, a method for controlling an autonomous vehicle is provided. The method may be performed by a computing system. The method includes recognizing surrounding objects around the autonomous vehicle and displaying the surrounding objects on a display guiding an autonomous driving situation. The method also includes receiving a user gesture for adjusting an inter-vehicle spacing between the autonomous vehicle and a spacing-adjustment target object selected from the surrounding objects displayed on the display. The method additionally includes transmitting a control signal to the autonomous vehicle to control the autonomous vehicle to travel according to the adjusted inter-vehicle spacing. The user gesture may include a first gesture of selecting at least one icon from among an spacing-adjustment target object icon representing the spacing-adjustment target object on the display and a present vehicle icon representing the autonomous vehicle on the display, and a second gesture of adjusting an inter-icon spacing using the at least one icon selected in the first gesture on the display.

In some embodiments, the first gesture may include selecting the spacing-adjustment target object icon and the present vehicle icon, and the second gesture may include adjusting an inter-icon spacing between the spacing-adjustment target object icon and the present vehicle icon.

In some embodiments, the spacing-adjustment target object may include an object preceding the autonomous vehicle on a driving path of the autonomous vehicle. The first gesture may include selecting the present vehicle icon, and the second gesture may include moving the present vehicle icon in a first direction as the same direction as a driving direction of each of the spacing-adjustment target object icon and the present vehicle icon or in a second direction opposite to the first direction.

In some embodiments, receiving the user gesture may include displaying an actual distance value corresponding to an appropriate inter-vehicle spacing between the spacing-adjustment target object and the autonomous vehicle on the display, and the appropriate inter-vehicle spacing may vary based on a type of the spacing-adjustment target object.

In some embodiments, receiving the user gesture may include displaying an actual distance value corresponding to the adjusted inter-vehicle spacing between the spacing-adjustment target object and the autonomous vehicle on the display while the user gesture is input.

In some embodiments, receiving the user gesture may further include, based on determining that the actual distance value is equal to or smaller than a first distance value, displaying the spacing-adjustment target object icon, the present vehicle icon, and a line icon connecting the spacing-adjustment target object icon and the present vehicle icon to each other using a first color.

In some embodiments, receiving the user gesture may include displaying an indication that the adjusted inter-vehicle spacing is not available on the display. Transmitting the control signal to the autonomous vehicle may include transmitting a first control signal to the autonomous vehicle to control the autonomous vehicle to travel according to an inter-vehicle spacing between the spacing-adjustment target object and the autonomous vehicle set before receiving the user gesture.

In some embodiments, receiving the user gesture may include displaying an indication that the adjusted inter-vehicle spacing is not available on the display. Transmitting the control signal to the autonomous vehicle may include transmitting a first control signal to the autonomous vehicle to control the autonomous vehicle to travel travels according to a preset appropriate inter-vehicle spacing between the spacing-adjustment target object and the autonomous vehicle.

In some embodiments, receiving the user gesture may further include, based on determining that the actual distance value exceeds a first distance value and is equal to or smaller than a second distance value, displaying the spacing-adjustment target object icon, the present vehicle icon, and a line icon connecting the spacing-adjustment target object icon and the present vehicle icon to each other using a second color.

In some embodiments, receiving the user gesture may further include, based on determining that the actual distance value exceeds a second distance value, displaying the spacing-adjustment target object icon, the present vehicle icon, and a line icon connecting the spacing-adjustment target object icon and the present vehicle icon to each other using a third color.

In some embodiments, recognizing the surrounding objects around the autonomous vehicle and displaying the surrounding objects on the display guiding the autonomous driving situation may include recognizing a type of each of the surrounding objects. The method may further include, in response to determining that a type of the spacing-adjustment target object is a first type, storing a first inter-vehicle spacing as information about the inter-vehicle spacing between a surrounding object of the first type and the autonomous vehicle, wherein the information is input according to the user gesture. The method may also include, in response to determining that the surrounding object of the first type precedes the autonomous vehicle on the driving path of the autonomous vehicle, transmitting a first control signal to the autonomous vehicle to control the autonomous vehicle to travel according to the first inter-vehicle spacing.

According to the aforementioned and other embodiments of the present disclosure, a method for controlling an autonomous vehicle is provided. The method may be performed by a computing system. The method includes recognizing surrounding objects around the autonomous vehicle and displaying the surrounding objects on a display guiding an autonomous driving situation. The method also includes receiving a user gesture for changing a current driving lane of the autonomous vehicle displayed on the display. The method additionally includes transmitting a control signal to the autonomous vehicle to control the autonomous vehicle to travel according to the changed driving lane. The user gesture may include a first gesture of selecting a present vehicle icon representing the autonomous vehicle on the display, and a second gesture of moving the present vehicle icon to a change target lane on the display.

In some embodiments, receiving the user gesture may include determining whether the autonomous vehicle is allowed to change the current driving lane to the change target lane, and based on determination that the autonomous vehicle is not allowed to change the current driving lane to the change target lane, displaying an indication that a lane change is not available on the display, in response to the user gesture. Transmitting the control signal to the autonomous vehicle may include transmitting a first control signal to the autonomous vehicle to control the autonomous vehicle to travel in the current driving lane on which the vehicle drives before receiving the user gesture.

According to the aforementioned and other embodiments of the present disclosure, a system for controlling an autonomous vehicle is provided. The system includes a communication interface, a memory into which a computer program is loaded, and one or more processors configured to execute the computer program. The computer program may include computer-readable instructions that, when the executed by the one or more processors, cause the one or more processors to: recognize surrounding objects around the autonomous vehicle and display the surrounding objects on a display guiding an autonomous driving situation; receive a user gesture for adjusting an inter-vehicle spacing between the autonomous vehicle and a spacing-adjustment target object selected from the surrounding objects displayed on the display; and transmit a control signal to the autonomous vehicle to control the autonomous vehicle to travel according to the adjusted inter-vehicle spacing. The user gesture may include a first gesture of selecting at least one of an spacing-adjustment target object icon representing the spacing-adjustment target object on the display and a present vehicle icon representing the autonomous vehicle on the display, and a second gesture of adjusting an inter-icon spacing using the at least one icon selected in the first gesture on the display.

In some embodiments, the computer-readable instructions, when executed by the one or more processors, may further cause the one or more processors to display an actual distance value corresponding to an appropriate inter-vehicle spacing between the spacing-adjustment target object and the autonomous vehicle on the display, wherein the appropriate inter-vehicle spacing may vary based on a type of the spacing-adjustment target object.

In some embodiments, the computer-readable instructions, when executed by the one or more processors, may further cause the one or more processors to display an actual distance value corresponding to the adjusted inter-vehicle spacing between the spacing-adjustment target object and the autonomous vehicle on the display while the user gesture is input.

In some embodiments, the computer-readable instructions, when executed by the one or more processors, may further cause the one or more processors to, based on determining that the actual distance value is equal to or smaller than a first distance value, display the spacing-adjustment target object icon, the present vehicle icon, and a line icon connecting the spacing-adjustment target object icon and the present vehicle icon to each other using a first color.

In some embodiments, the computer-readable instructions, when executed by the one or more processors, may further cause the one or more processors to, based on determining that the actual distance value exceeds a first distance value and is equal to or smaller than a second distance value, display the spacing-adjustment target object icon, the present vehicle icon, and a line icon connecting the spacing-adjustment target object icon and the present vehicle icon to each other using a second color.

In some embodiments, the computer-readable instructions, when executed by the one or more processors, may further cause the one or more processors to, based on determining that the actual distance value exceeds a second distance value, displaying the spacing-adjustment target object icon, the present vehicle icon, and a line icon connecting the spacing-adjustment target object icon and the present vehicle icon to each other using a third color.

In some embodiments, the computer-readable instructions, when executed by the one or more processors, may further cause the one or more processors to recognize a type of each of the surrounding objects. The computer-readable instructions, when executed by the processor, may also cause the one or more processors to, in response to that determining that a type of the spacing-adjustment target object is a first type, store a first inter-vehicle spacing as information about the inter-vehicle spacing between a surrounding object of the first type and the autonomous vehicle, wherein the information is input according to the user gesture. The computer-readable instructions, when executed by the processor, may also cause the one or more processors to, in response to determining that the surrounding object of the first type precedes the autonomous vehicle on a driving path of the autonomous vehicle, transmitting a first control signal to the autonomous vehicle to control the autonomous vehicle to travel according to the first inter-vehicle spacing.

Specific details of these and other embodiments are included in the detailed description and drawings.

### BRIEF DESCRIPTION OF THE DRAWINGS

The above and other aspects and features of the present disclosure should become more apparent from the following detailed description taken in conjunction with the accompanying drawings, in which:

FIG. 1 is a system configuration diagram for illustrating a configuration and an operation of a vehicle system according to some embodiments of the present disclosure;

FIG. 2 is a flowchart illustrating a method for controlling an autonomous vehicle according to some embodiments of the present disclosure;

FIG. 3 is an example diagram for illustrating a method for receiving a user gesture according to some embodiments of the present disclosure;

FIG. 4 is an example diagram for illustrating a method for receiving a user gesture according to some embodiments of the present disclosure;

FIG. 5 is an example diagram for illustrating a method for displaying an appropriate inter-vehicle spacing on a display screen according to some embodiments of the present disclosure;

FIG. 6 is an example diagram for illustrating a method for displaying a current inter-vehicle spacing on a display screen according to some embodiments of the present disclosure;

FIG. 7 is an example diagram for illustrating a method for receiving a user gesture according to some embodiments of the present disclosure;

FIG. 8 is an example diagram for illustrating a method for receiving a user gesture according to some embodiments of the present disclosure;

FIG. 9 is a flowchart illustrating a method for controlling an autonomous vehicle according to some embodiments of the present disclosure;

FIG. 10 is a flowchart illustrating a method for controlling an autonomous vehicle according to some embodiments of the present disclosure;

FIG. 11 is an example diagram for illustrating a method for changing a driving lane of an autonomous vehicle based on a user gesture according to some embodiments of the present disclosure.

FIG. 12 is an example diagram for illustrating a method for changing a driving lane of an autonomous vehicle based on a user gesture according to some embodiments of the present disclosure.

FIG. 13 is a hardware configuration diagram of a computing device described in some embodiments of the present disclosure.

### DETAILED DESCRIPTION

Hereinafter, embodiments of the present disclosure are described in detail with reference to the accompanying drawings. Advantages and features of the present disclosure and methods of accomplishing the same should be more clearly understood from the following detailed description taken in conjunction with the accompanying drawings. The present disclosure may, however, be embodied in many different forms and should not be construed as being limited to the embodiments set forth herein. Rather, these embodiments are provided to make the present disclosure thorough and complete and to fully convey the concept of the present disclosure to those having ordinary skill in the art, and the present disclosure is defined only by the appended claims.

In adding reference numerals to the components of each drawing, it should be noted that the same reference numerals are assigned to the same components as much as possible even when the components are shown in different drawings. In addition, in describing the present disclosure, where it was determined that a detailed description of the related well-known configuration or function would obscure the gist of the present disclosure, the detailed description thereof has been omitted.

Unless otherwise defined, all terms used in the present specification (including technical and scientific terms) may be used in a sense that can be commonly understood by those having ordinary skill in the art. In addition, the terms defined in the commonly used dictionaries should not be ideally or excessively interpreted unless they are specifically defined otherwise herein. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are used merely to distinguish the components from other components, and the nature or order of the components is not limited by the terms. If a component is described as being “connected,” “coupled” or “contacted” to another component, the component may be directly connected to or contacted with the other component, but it should be understood that another component also may be “connected,” “coupled” or “contacted” between the two components.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings.

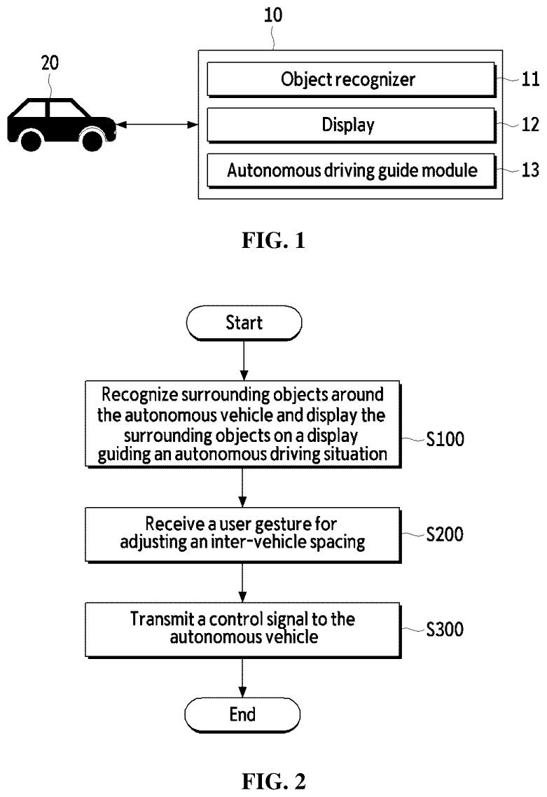

Hereinafter, a configuration and an operation of a vehicle system according to some embodiments of the present disclosure is described with reference to FIG. 1. FIG. 1 is a system configuration diagram for illustrating the configuration and the operation of the vehicle system according to some embodiments of the present disclosure.

Referring to FIG. 1, the vehicle system may include an autonomous driving system 10 and an autonomous vehicle 20. However, the scope of the present disclosure is not limited thereto. In some cases, the vehicle system may be configured in a form further including a module/device/system not shown in FIG. 1. In some cases, the vehicle system may be configured in a form in which at least some of the components 10 to 20 illustrated in FIG. 1 are excluded.

The autonomous driving system 10 may include an object recognizer 11, a display 12, and an autonomous driving guide module 13. However, the scope of the present disclosure is not limited thereto. For example, in some cases, the autonomous driving system 10 may be configured in a form further including a module/device/system not shown in FIG. 1. In some cases, the autonomous driving system 10 may be configured in a form in which at least some of the components 11 to 13 illustrated in FIG. 1 are excluded.

The object recognizer 11 may recognize a surrounding object around the autonomous vehicle 20 and may recognize a surrounding situation during autonomous driving. The object recognizer 11 may detect the surrounding environment and may identify a position and a type of the object using various sensors such as a camera, a LiDAR, a radar, etc., mounted on the autonomous vehicle 20, and may provide information necessary for driving of the vehicle based on the detection and identifying result. The object recognizer 11 may collect data on the surrounding situation using the various sensors, preprocess the collected data, and detect and classify the surrounding object based on the preprocessed data. The operation of the object recognizer 11 is already well-known to a person having ordinary skill in the art to which the present disclosure pertains, and thus a detailed description thereof has been omitted.

The display 12 may display the autonomous driving situation recognized by the object recognizer 11 on a display in the autonomous vehicle 20. The display may be installed inside the autonomous vehicle 20. A user who drives the autonomous vehicle may recognize the autonomous driving situation displayed on the display. The user may select an spacing-adjustment target object from among the surrounding objects displayed on the display, and may input a user gesture for adjusting an inter-vehicle spacing between the selected spacing-adjustment target object and the autonomous vehicle 20.

In addition, the user may input a user gesture for changing a driving lane of the autonomous vehicle 20 displayed on the display.

The display 12 may display feedback in response to the input of the user gesture on the display. This is described in more detail below with reference to FIG. 2.

The autonomous driving guide module 13 may determine whether the inter-vehicle spacing between the autonomous vehicle 20 and the spacing-adjustment target object may be adjusted based on the user gesture input through the display 12. The autonomous driving guide module 13 may determine whether to transmit a control signal to the autonomous vehicle 20 to control the autonomous vehicle 20 to travel according to the adjusted inter-vehicle spacing based on the determination result.

In addition, the autonomous driving guide module 13 may determine whether the driving lane of the autonomous vehicle 20 may be changed, based on the user gesture input through the display 12. The autonomous driving guide module 13 may determine whether to transmit a control signal to the autonomous vehicle 20 to control the autonomous vehicle 20 to travel according to the changed driving lane based on the determination result.

The autonomous vehicle 20 may receive the control signal from the autonomous driving guide module 13 and may drive according to the control signal.

As described above, the autonomous driving or autonomous driving system 10 according to embodiments of the present disclosure may be a concept that includes all levels from ‘partial autonomous driving’ that requires partial manipulation by a human driver to ‘fully autonomous driving’ that does not require any manipulation by a human driver. For example, the autonomous driving or the autonomous driving system 10 according to embodiments of the present disclosure may be a concept that includes all of the autonomous driving levels 1 to 5.

Hereinafter, in order to provide convenience of understanding, in the description below, it may be assumed that all steps/operations of methods to be described below are performed in the above-described autonomous driving system 10. Accordingly, when a subject of a specific step/operation is omitted, it may be understood that the autonomous driving system 10 performs the operation/step. However, in an actual environment, some steps/operations of the method to be described below may be performed in other computing devices.

Hereinafter, a method for controlling an autonomous vehicle according to some embodiments of the present disclosure is described in more detail with reference to FIG. 2. FIG. 2 is a flowchart illustrating a method for controlling an autonomous vehicle according to some embodiments of the present disclosure.

Referring to FIG. 2, in an operation S100, the object recognizer 11 may recognize a surrounding object around the autonomous vehicle 20, and the display 12 may display the surrounding object on a screen guiding an autonomous driving situation. As described above, the object recognizer 11 may detect the surrounding environment and identify the position and type of the object using various sensors such as a camera, a LiDAR, a radar, etc., mounted on the autonomous vehicle 20, and provide information necessary for driving of the vehicle based on the detection and identifying result. The object recognizer may collect data on the surrounding situation using the various sensors, preprocess the collected data, and detect and classify surrounding objects based on the preprocessed data. The operation of the object recognizer 11 is already well-known to a person having ordinary skill in the art to which the present disclosure pertains, and thus a detailed description thereof has been omitted.

In an operation S200, the display 12 may receive the user gesture for adjusting an inter-vehicle spacing between the autonomous vehicle 20 and the spacing-adjustment target object selected from the surrounding objects displayed on the display. The user gesture may include a first gesture of selecting at least one of an spacing-adjustment target object icon representing the spacing-adjustment target object on the display and a present vehicle icon representing the autonomous vehicle 20 on the display, and a second gesture for adjusting an inter-icon spacing using the at least one icon selected in the first gesture on the display. The inter-vehicle spacing may mean an inter-vehicle spacing between the autonomous vehicle 20 and an object that is front thereof on a driving path of the autonomous vehicle and/or an inter-vehicle spacing between the autonomous vehicle 20 and an object that is driving right next to the autonomous vehicle 20. However, the scope of the present disclosure is not limited thereto.

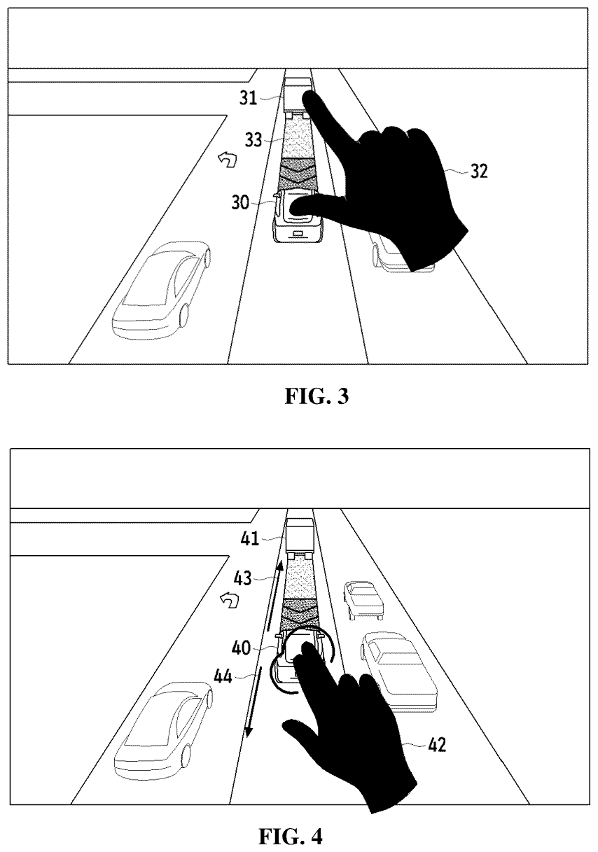

Operation S200, according to an embodiment, is described in more detail below with reference to FIGS. 3-8 .

Thereafter, the autonomous driving guide module 13 may determine whether the inter-vehicle spacing between the autonomous vehicle 20 and the spacing-adjustment target object may be adjusted based on the user gesture input through the display 12. In an operation S300, the autonomous driving guide module 13 may transmit a control signal to the autonomous vehicle 20 to control the autonomous vehicle 20 to travel according to the inter-vehicle spacing adjusted according to the user gesture by using the determination result.

The autonomous vehicle 20 may receive the control signal from the autonomous driving guide module 13 and may drive according to the control signal.

According to the present embodiment, a user who drives the autonomous vehicle 20 may easily control an inter-vehicle spacing between the autonomous vehicle 20 and a surrounding object around the autonomous vehicle 20 through a user interface screen displayed on a display installed inside the autonomous vehicle 20. Therefore, according to the present embodiment, there is an advantage in that, in controlling the inter-vehicle spacing between the autonomous vehicle and another driving object, user convenience and user experience may be maximized.

Hereinafter, a method for receiving a user gesture according to some embodiments of the present disclosure is described with reference to FIG. 3. FIG. 3 is an example diagram for illustrating a method for receiving a user gesture according to some embodiments of the present disclosure.

In an embodiment, the first gesture may be selecting an spacing-adjustment target object icon representing the spacing-adjustment target object on the display and the present vehicle icon representing the autonomous vehicle 20 on the display. The second gesture may be adjusting a spacing between the spacing-adjustment target object icon and the present vehicle icon.

Referring to FIG. 3, a display in which a present vehicle icon 30 and an spacing-adjustment target object icon 31 are displayed is illustrated. In the first gesture 32, the user may touch the present vehicle icon 30 and the spacing-adjustment target object icon 31 together on the display. In the second gesture 32, the user may adjust a spacing 33 between the present vehicle icon 30 and the spacing-adjustment target object icon 31.

In this case, the autonomous driving guide module 13 may transmit a control signal to the autonomous vehicle 20 to control the autonomous vehicle 20 to travel according to the inter-vehicle spacing adjusted by the user gesture 32 input through the display 12.

The autonomous vehicle 20 may receive the control signal from the autonomous driving guide module 13 and may drive according to the control signal.

According to the present embodiment, the user who drives the autonomous vehicle 20 may easily control the inter-vehicle spacing between the autonomous vehicle 20 and the spacing-adjustment target object by setting the spacing between the present vehicle icon and the spacing-adjustment target object icon in a pinch-to-zoom manner on the user interface screen displayed on the display installed inside the autonomous vehicle 20. Therefore, according to the present embodiment, there is an advantage in that, in controlling the inter-vehicle spacing between the autonomous vehicle and another driving object, user convenience and user experience may be maximized.

In another embodiment, unlike in the embodiment illustrated in FIG. 3, the user may select, in the first gesture, the present vehicle icon and a driving object icon presenting a driving object traveling next to the present vehicle. Thereafter, in the second gesture, the user may adjust a spacing between the driving object icon and the present vehicle icon.

In this case, the autonomous driving guide module 13 may transmit a control signal to the autonomous vehicle 20 to control the autonomous vehicle 20 to travel according to an inter-vehicle spacing adjusted by the user gesture 32 input through the display 12.

The autonomous vehicle 20 may receive the control signal from the autonomous driving guide module 13 and may drive according to the control signal.

That is, according to the present embodiment, the user may also adjust the inter-vehicle spacing between the autonomous vehicle 20 and the object driving next to the autonomous vehicle 20 by inputting the user gesture.

Hereinafter, a method for receiving a user gesture according to some embodiments of the present disclosure is described with reference to FIG. 4. FIG. 4 is an example diagram for illustrating a method for receiving a user gesture according to some embodiments of the present disclosure.

In an embodiment, the spacing-adjustment target object selected from the surrounding objects displayed on the display may be an object that is in front of the present vehicle on the driving path of the autonomous vehicle 20, the first gesture may be to select the present vehicle icon, and the second gesture may be to move the present vehicle icon in a first direction that is the same direction as the driving direction of the spacing-adjustment target object icon and the present vehicle icon or in a second direction that is opposite to the first direction. Accordingly, when the user touches only the present vehicle icon through the first gesture, the spacing-adjustment target object may be selected as an object preceding the present vehicle in the driving route of the autonomous vehicle 20. In a second gesture, the user may adjust the inter-vehicle spacing between the spacing-adjustment target object and the autonomous vehicle 20 by moving the object icon in a first direction that is the same direction as the driving direction of the spacing-adjustment target object icon and the object icon in the present vehicle or in a second direction that is opposite to the first direction.

Referring to FIG. 4, a display on which a present vehicle icon 40 and an spacing-adjustment target object icon 41 are displayed is illustrated. In the first gesture 42, the user may touch only the present vehicle icon 30 on the display. In the second gesture 42, the user may move the present vehicle icon 40 in the first direction 43 that is the same direction as the driving direction of the present vehicle icon 40 and the spacing-adjustment target object icon 41, thereby setting the inter-vehicle spacing between the surrounding vehicle corresponding to the spacing-adjustment target object icon 41 and the autonomous vehicle 20 corresponding to the present vehicle icon 40 to be smaller than a current inter-vehicle spacing.

On the other hand, in the first gesture 42, the user may touch only the present vehicle icon 30 on the display. in the second gesture 42, the user may move the present vehicle icon 40 in the second direction 44 opposite to the first direction 43 which is the same direction as the driving direction of the present vehicle icon 40 and the spacing-adjustment target object icon 41, thereby setting the inter-vehicle spacing between the spacing-adjustment target object corresponding to the spacing-adjustment target object icon 41 and the autonomous vehicle 20 corresponding to the present vehicle icon 40 to be greater than a current inter-vehicle spacing.

According to the present embodiment, the user who drives the autonomous vehicle 20 may easily control the inter-vehicle spacing between the autonomous vehicle 20 and the spacing-adjustment target object by moving only the present vehicle icon so as to set the spacing between the present vehicle icon and the spacing-adjustment target object on the user interface screen displayed on the display installed inside the autonomous vehicle 20. Therefore, according to the present embodiment, there is an advantage in that, in controlling the inter-vehicle spacing between the autonomous vehicle and another driving object, user convenience and user experience may be maximized.

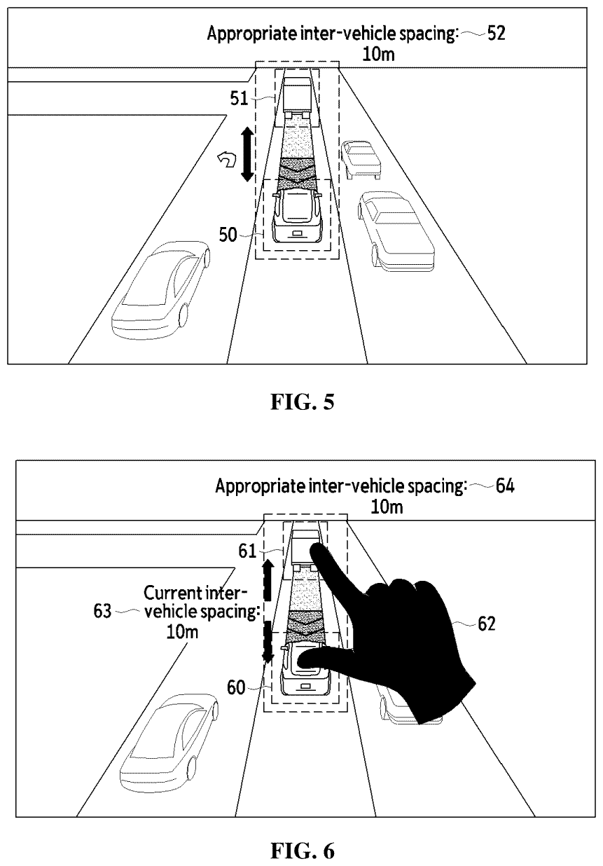

Hereinafter, referring to FIG. 5, a method for displaying an appropriate inter-vehicle spacing on a display screen according to some embodiments of the present disclosure is described. FIG. 5 is an example diagram for illustrating a method for displaying an appropriate inter-vehicle spacing on a display screen according to some embodiments of the present disclosure.

In an embodiment, the display 12 may display, on the display, an actual distance value corresponding to a predetermined appropriate inter-vehicle spacing between the spacing-adjustment target object and the autonomous vehicle 20. The appropriate inter-vehicle spacing may vary according to the type of the spacing-adjustment target object. In an example, when the type of the spacing-adjustment target object is a truck, the appropriate inter-vehicle spacing may be greater than that when the type of the spacing-adjustment target object is a passenger car. In another example, when the type of the spacing-adjustment target object is a motorcycle, an appropriate inter-vehicle spacing may be greater than that when the type of the spacing-adjustment target object is a passenger car. However, the appropriate inter-vehicle spacing may be set to vary according to circumstances, and the scope of the present disclosure is not limited thereto.

Referring to FIG. 5, a display in which a present vehicle icon 50 and an spacing-adjustment target object icon 51 are displayed is illustrated. The display 12 may display, on the display, an actual distance value corresponding to an appropriate inter-vehicle spacing 52 between the spacing-adjustment target object corresponding to the spacing-adjustment target object icon 51 and the autonomous vehicle 20 corresponding to the present vehicle icon 50, which is preset and is 10 m. In this case, the appropriate inter-vehicle spacing set according to the type of the spacing-adjustment target object may be 10 meters (m).

According to the present embodiment, a user who drives the autonomous vehicle 20 may set an inter-vehicle spacing between the spacing-adjustment target object and the autonomous vehicle 20 by referring to the appropriate inter-vehicle spacing between the present vehicle and the spacing-adjustment target object through a user interface screen displayed on a display installed inside the autonomous vehicle 20. Therefore, according to the present embodiment, there is an advantage in that driving stability may be improved in an autonomous driving environment. In addition, according to the present embodiment, there is an advantage in that, in controlling the inter-vehicle spacing between the autonomous vehicle and another driving object, user convenience and user experience may be maximized.

In an embodiment, the appropriate inter-vehicle spacing may be a value set to vary according to a type of a road on which the autonomous vehicle 20 is driving. For example, when the road on which the autonomous vehicle 20 is driving is a highway, the appropriate inter-vehicle spacing may be set to be greater than the appropriate inter-vehicle spacing when the road on which the autonomous vehicle 20 is driving is a general road. However, the appropriate inter-vehicle spacing may be set to vary according to circumstances, and the scope of the present disclosure is not limited thereto.

Hereinafter, a method for displaying a current inter-vehicle spacing on a display screen according to some embodiments of the present disclosure is described with reference to FIG. 6. FIG. 6 is an example diagram for illustrating a method for displaying a current inter-vehicle spacing on a display screen according to some embodiments of the present disclosure.

In an embodiment, while a user gesture for adjusting an inter-vehicle spacing between the spacing-adjustment target object and the autonomous vehicle 20 is input, the display 12 may display an actual distance value between the spacing-adjustment target object and the autonomous vehicle 20 corresponding to the adjusted spacing between the spacing-adjustment target object icon and the present vehicle icon on the display.

Referring to FIG. 6, a display on which a present vehicle icon 60 and an spacing-adjustment target object icon 61 are displayed is illustrated. While the user gesture 62 is input, the display 12 may display, on the screen, that the actual distance value corresponding to a current inter-vehicle spacing 63 between the spacing-adjustment target object and the autonomous vehicle 20 is 10 m. In this case, the display 12 may display, on the screen, that the actual distance value corresponding to the appropriate inter-vehicle spacing 64 between the spacing-adjustment target object and the autonomous vehicle 20 is 10 m.

In another embodiment, when the actual distance value corresponding to the adjusted inter-vehicle spacing between the spacing-adjustment target object and the autonomous vehicle 20 exceeds a first distance value and is smaller than or equal to a second distance value, the display 12 may display the spacing-adjustment target object icon 61, the present vehicle icon 60, and a line icon connecting the spacing-adjustment target object icon 61 and the present vehicle icon 60 to each other using a second color.

The first distance value and the second distance value may be preset values in the autonomous driving system 10. The first distance value may be a value smaller than the actual distance value corresponding to the appropriate inter-vehicle spacing 64 between the spacing-adjustment target object and the autonomous vehicle 20 preset by the autonomous driving system 20. For example, the actual distance value corresponding to the appropriate inter-vehicle spacing 64 between the spacing-adjustment target object and the autonomous vehicle 20 preset by the autonomous driving system 20 may be 10 m, and the first distance value may be 2 m. However, any first distance value smaller than the actual distance value corresponding to the appropriate inter-vehicle spacing 64 between the spacing-adjustment target object and the autonomous vehicle 20 which is preset by the autonomous driving system 20 may be available. The first distance value may be set to vary depending on the situation.

The second distance value may be a value greater than the actual distance value corresponding to the appropriate inter-vehicle spacing 64 between the spacing-adjustment target object and the autonomous vehicle 20 preset by the autonomous driving system 20. For example, the actual distance value corresponding to the appropriate inter-vehicle spacing 64 between the spacing-adjustment target object and the autonomous vehicle 20 preset by the autonomous driving system 20 may be 10 m, and the second distance value may be 20 m. However, any second distance value greater than the actual distance value corresponding to the appropriate inter-vehicle spacing 64 between the spacing-adjustment target object and the autonomous vehicle 20 which is preset by the autonomous driving system 20 may be available. The second distance value may be set to vary depending on the situation.

Accordingly, in this embodiment, when the actual distance value corresponding to the adjusted inter-vehicle spacing between the spacing-adjustment target object and the autonomous vehicle 20 exceeds the first distance value and is smaller than or equal to the second distance value, this may mean that the actual distance value corresponding to the adjusted inter-vehicle spacing between the spacing-adjustment target object and the autonomous vehicle 20 maintains an appropriate inter-vehicle distance between the spacing-adjustment target object and the autonomous vehicle. In this case, the display 12 may display the spacing-adjustment target object icon 61, the present vehicle icon 60, and the line icon connecting the spacing-adjustment target object icon 61 and the present vehicle icon 60 to each other using the second color, thereby indicating that the inter-vehicle spacing between the spacing-adjustment target object and the autonomous vehicle 20 is appropriate. The second color may be, for example, green. However, the scope of the disclosure is not limited thereto. For example, the second color may be set to any color as long as it is a color capable of indicating that the inter-vehicle spacing between the spacing-adjustment target object and the autonomous vehicle 20 is appropriate.

According to the present embodiment, a user who drives the autonomous vehicle 20 may be provided with feedback indicating that the inter-vehicle spacing between the spacing-adjustment target object and the autonomous vehicle 20 is appropriate. Therefore, according to the present embodiment, the user who drives the autonomous vehicle 20 may set the inter-vehicle spacing between the spacing-adjustment target object and the autonomous vehicle 20 by referring to the appropriate inter-vehicle spacing relative to the spacing-adjustment target object through a user interface screen displayed on a display installed inside the autonomous vehicle 20. Therefore, according to the present embodiment, there is an advantage in that driving stability may be improved in an autonomous driving environment. In addition, according to the present embodiment, there is an advantage in that user convenience and user experience may be maximized in controlling the inter-vehicle spacing between the autonomous vehicle and other driving objects.

In another embodiment, when the actual distance value corresponding to the adjusted inter-vehicle spacing between the spacing-adjustment target object and the autonomous vehicle 20 exceeds the second distance value, the display 12 may display the spacing-adjustment target object icon 61, the present vehicle icon 60, and the line icon connecting the spacing-adjustment target object icon 61 and the present vehicle icon 60 to each other using a third color.

The second distance value may be a preset value in the autonomous driving system 10. The second distance value may be a value greater than an actual distance value corresponding to an appropriate inter-vehicle spacing 64 between the spacing-adjustment target object and the autonomous vehicle 20 preset by the autonomous driving system 20. For example, an actual distance value corresponding to the appropriate inter-vehicle spacing 64 between the spacing-adjustment target object and the autonomous vehicle 20 preset by the autonomous driving system 20 may be 10 m, and the second distance value may be 20 m. However, any second distance value greater than the actual distance value corresponding to the appropriate inter-vehicle spacing 64 between the spacing-adjustment target object and the autonomous vehicle 20 which is preset by the autonomous driving system 20 may be available. The second distance value may be set to vary depending on the situation.

Accordingly, in the present embodiment, when the actual distance value corresponding to the adjusted inter-vehicle spacing between the spacing-adjustment target object and the autonomous vehicle 20 exceeds the second distance value, this may mean that the actual distance value corresponding to the adjusted inter-vehicle spacing between the spacing-adjustment target object and the autonomous vehicle 20 is greater than the appropriate inter-vehicle spacing between the spacing-adjustment target object and the autonomous vehicle 20. In this case, the display 12 may display the spacing-adjustment target object icon 61, the present vehicle icon 60, and the line icon connecting the spacing-adjustment target object icon 61 and the present vehicle icon 60 to each other using the third color, thereby indicating that the inter-vehicle spacing between the spacing-adjustment target object and the autonomous vehicle 20 is too great compared to the general situation. The third color may be, for example, black. However, the scope of the disclosure is not limited thereto. For example, the third color may be set to any color as long as it is a color capable of indicating that the inter-vehicle spacing between the spacing-adjustment target object and the autonomous vehicle 20 is too large.

According to the present embodiment, feedback on the fact that the inter-vehicle spacing between the spacing-adjustment target object and the autonomous vehicle 20 is too great may be provided to the user who drives the autonomous vehicle 20. Therefore, according to the present embodiment, the user who drives the autonomous vehicle 20 may set the inter-vehicle spacing between the spacing-adjustment target object and the autonomous vehicle 20 by referring to the appropriate inter-vehicle spacing with respect to the spacing-adjustment target object through a user interface screen displayed on a display installed inside the autonomous vehicle 20. Therefore, according to the present embodiment, there is an advantage in that driving stability may be improved in an autonomous driving environment. In addition, according to the present embodiment, there is an advantage in that, in controlling the inter-vehicle spacing between the autonomous vehicle and another driving object, user convenience and user experience may be maximized.

In another embodiment, when the actual distance value corresponding to the adjusted inter-vehicle spacing between the spacing-adjustment target object and the autonomous vehicle 20 is equal to or smaller than the first distance value, the display 12 may display the spacing-adjustment target object icon 61, the present vehicle icon 60, and the line icon connecting the spacing-adjustment target object icon 61 and the present vehicle icon 60 to each other using the first color.

The first distance value may be a preset value in the autonomous driving system 10. The first distance value may be a value smaller than an actual distance value corresponding to the appropriate inter-vehicle spacing 64 between the spacing-adjustment target object and the autonomous vehicle 20 preset by the autonomous driving system 20. For example, the actual distance value corresponding to an appropriate inter-vehicle spacing 64 between the spacing-adjustment target object and the autonomous vehicle 20 preset by the autonomous driving system 20 may be 10 m, and the first distance value may be 2 m. However, any first distance value smaller than the actual distance value corresponding to the appropriate inter-vehicle spacing 64 between the spacing-adjustment target object and the autonomous vehicle 20 which is preset by the autonomous driving system 20 may be available. The first distance value may be set to vary depending on the situation.

Accordingly, in this embodiment, when the actual distance value corresponding to the adjusted inter-vehicle spacing between the spacing-adjustment target object and the autonomous vehicle 20 is equal to or smaller than the first distance value, this may mean that the actual distance value corresponding to the adjusted inter-vehicle spacing between the spacing-adjustment target object and the autonomous vehicle 20 is smaller than the appropriate inter-vehicle spacing between the spacing-adjustment target object and the autonomous vehicle 20. In this case, the display 12 may display the spacing-adjustment target object icon 61, the present vehicle icon 60, and the line icon connecting the spacing-adjustment target object icon 61 and the present vehicle icon 60 to each other using the first color, thereby indicating that the inter-vehicle spacing between the spacing-adjustment target object and the autonomous vehicle 20 is too small compared to the general situation. The first color may be, for example, red. However, the scope of the disclosure is not limited thereto, and the first color may be set to any color as long as it is a color capable of indicating that the inter-vehicle spacing between the spacing-adjustment target object and the autonomous vehicle 20 is too small.

According to the present embodiment, feedback on the fact that the inter-vehicle spacing between the spacing-adjustment target object and the autonomous vehicle 20 is too small may be provided to the user who drives the autonomous vehicle 20. Therefore, according to the present embodiment, the user who drives the autonomous vehicle 20 may set the inter-vehicle spacing between the spacing-adjustment target object and the autonomous vehicle 20 by referring to an appropriate inter-vehicle spacing with respect to the spacing-adjustment target object through a user interface screen displayed on a display installed inside the autonomous vehicle 20. Therefore, according to the present embodiment, there is an advantage in that driving stability may be improved in an autonomous driving environment. In addition, according to the present embodiment, there is an advantage in that, in controlling the inter-vehicle spacing between the autonomous vehicle and another driving object, user convenience and user experience may be maximized.

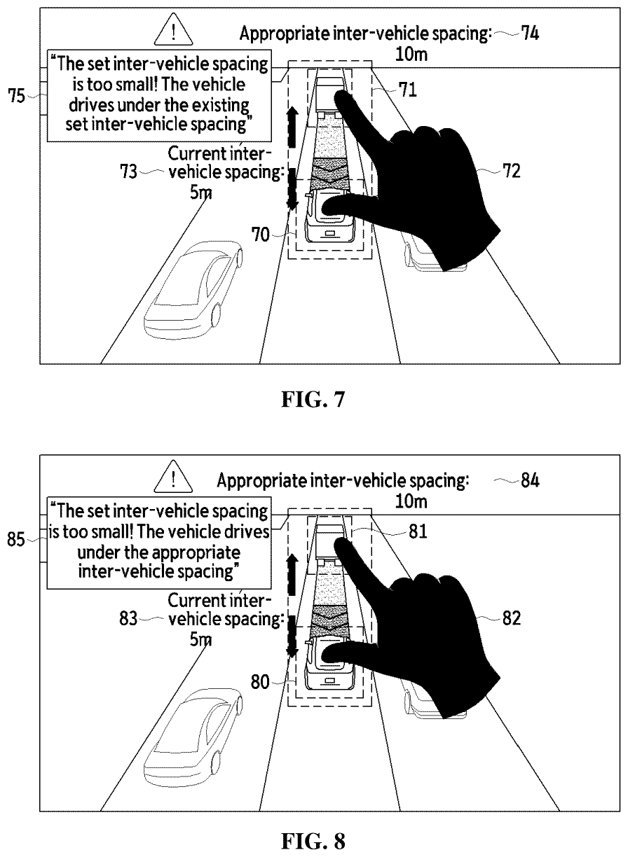

In this embodiment, the actual distance value corresponding to the adjusted inter-vehicle spacing between the spacing-adjustment target object and the autonomous vehicle 20 is much smaller than the appropriate inter-vehicle spacing between the spacing-adjustment target object and the autonomous vehicle 20, such that when the autonomous vehicle 20 to travel according to the adjusted inter-vehicle spacing, there is a high possibility that a large accident may occur due to a non-safe distance between the spacing-adjustment target object and the autonomous vehicle 20. Therefore, an embodiment in preparation for such a case is described in detail with reference to FIGS. 7 and 8. FIGS. 7 and 8 are example diagrams for illustrating a method for receiving a user gesture according to some embodiments of the present disclosure.

First, an embodiment of a method for receiving a user gesture is described with reference to FIG. 7.

In an embodiment, the display 12 may display, on the screen, an indication that the adjusted inter-vehicle spacing cannot be available in the above situation. Thereafter, the autonomous driving guide module 13 may transmit a first control signal to the autonomous vehicle 20 to control the autonomous vehicle 20 to travel according to the inter-vehicle spacing between the spacing-adjustment target object and the autonomous vehicle 20 as set before receiving the user gesture. The indication that the adjusted inter-vehicle spacing cannot be available may be displayed on the display in the form of a pop-up message. However, the scope of the present disclosure is not limited thereto. The indication that the adjusted inter-vehicle spacing cannot be available may be of any type as long as it may inform the user that the adjusted inter-vehicle spacing between the spacing-adjustment target object and the autonomous vehicle 20 is not available.

Referring to FIG. 7, a display showing a present vehicle icon 70 and an spacing-adjustment target object icon 71 is illustrated. In this regard, this embodiment is described on the assumption that an appropriate inter-vehicle spacing 74 between the autonomous vehicle 20 corresponding to the present vehicle icon 70 and the spacing-adjustment target object corresponding to the spacing-adjustment target object icon 71 is 10 m, and the user operating the autonomous vehicle 20 sets the inter-vehicle spacing 73 between the present vehicle icon 70 and the spacing-adjustment target object 71 to 5 m through a user gesture 72.

In this case, the display 12 may display the indication 75 that the adjusted inter-vehicle spacing 73 cannot be available on the screen. The indication 75 that the adjusted inter-vehicle spacing 73 cannot be available, for example, in the form of a pop-up message, and may be ‘The set inter-vehicle spacing is too small! The vehicle drives under the existing set inter-vehicle spacing’ together with a warning sign. Thereafter, together with the indication 75 that the adjusted inter-vehicle spacing 73 cannot be available, the autonomous driving guide module 13 may transmit the first control signal to the autonomous vehicle 20 to control the autonomous vehicle 20 to travel according to the inter-vehicle spacing between the spacing-adjustment target object and the autonomous vehicle 20 as set before receiving the user gesture.

In this regard, the actual distance value corresponding to the adjusted inter-vehicle spacing between the spacing-adjustment target object and the autonomous vehicle 20 is much smaller than the appropriate inter-vehicle spacing between the spacing-adjustment target object and the autonomous vehicle 20. Thus, when the autonomous vehicle 20 drives according to the adjusted inter-vehicle spacing, a serious accident may occur due to the non-safe distance between the spacing-adjustment target object and the autonomous vehicle 20. However, according to the present embodiment, this situation may be prevented in a proactive manner, thereby improving driving stability in the autonomous driving environment.

Hereinafter, an embodiment of a method for receiving a user gesture is described with reference to FIG. 8.

In an embodiment, the display 12 may display, on the screen, the indication that the adjusted inter-vehicle spacing cannot be available in the above situation. Thereafter, the autonomous driving guide module 13 may transmit the first control signal to the autonomous vehicle 20 to control the autonomous vehicle 20 to travel according to a preset appropriate inter-vehicle spacing between the spacing-adjustment target object and the autonomous vehicle 20. The non-indication that the adjusted inter-vehicle spacing cannot be available may be displayed on the display in the form of a pop-up message. However, the scope of the present disclosure is not limited thereto. The indication that the adjusted inter-vehicle spacing cannot be available may be of any type as long as it may inform the user that the adjusted inter-vehicle spacing between the spacing-adjustment target object and the autonomous vehicle 20 is currently not available.

Referring to FIG. 8, a display showing a present vehicle icon 80 and an spacing-adjustment target object icon 81 is illustrated. In this case, the present disclosure is described on the assumption that the appropriate inter-vehicle spacing 84 between the autonomous vehicle 20 corresponding to the present vehicle icon 80 and the spacing-adjustment target object corresponding to the spacing-adjustment target object icon 8 is 10 m, and the user operating the autonomous vehicle 20 sets the inter-vehicle spacing 83 between the present vehicle icon 80 and the spacing-adjustment target object icon 81 to 5 m through a user gesture 82.

In this case, the display 12 may display the indication 85 that the adjusted inter-vehicle spacing 83 cannot be available on the screen. The indication 85 that the adjusted inter-vehicle spacing cannot be available, may be presented, for example, in the form of a pop-up message, and may be ‘The set inter-vehicle spacing is too small! The vehicle drives under the appropriate inter-vehicle spacing’ together with a warning sign. Thereafter, together with the indication 85 that the adjusted inter-vehicle spacing 83 cannot be available, the autonomous driving guide module 13 may transmit the first control signal to the autonomous vehicle 20 to control the autonomous vehicle 20 to travel according to a preset appropriate inter-vehicle spacing between the spacing-adjustment target object and the autonomous vehicle 20.

As described above, the actual distance value corresponding to the adjusted inter-vehicle spacing between the spacing-adjustment target object and the autonomous vehicle 20 is much smaller than the appropriate inter-vehicle spacing between the spacing-adjustment target object and the autonomous vehicle 20, so that when the autonomous vehicle 20 travels according to the adjusted inter-vehicle spacing, a serious accident may occur due to the lack of securing of the safe distance between the spacing-adjustment target object and the autonomous vehicle 20. However, according to the present embodiment, this situation may be prevented in a proactive manner, thereby improving driving stability in the autonomous driving environment.

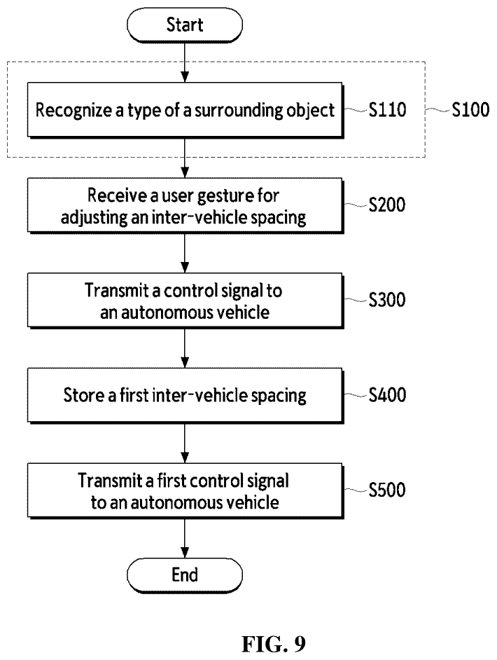

Hereinafter, a method for controlling an autonomous vehicle according to some embodiments of the present disclosure is described with reference to FIG. 9. FIG. 9 is a flowchart illustrating a method for controlling an autonomous vehicle according to some embodiments of the present disclosure.

Referring to FIG. 9, the object recognizer 11 may recognize a type of a surrounding object around the autonomous vehicle in an operation S110. The type of the surrounding object refers to a vehicle type of the surrounding driving object, and may refer to, for example, a truck, a car, a motorcycle, a bus, or the like. This is the same as the description of operation S100 described above with reference to FIG. 2, and thus a detailed description thereof is not repeated for the purpose of conciseness.

In an operation S200, the display 12 may receive a user gesture for adjusting an inter-vehicle spacing between the spacing-adjustment target object selected from among the surrounding objects displayed on the display and the autonomous vehicle 20. Since operation S200 is the same as described with reference to FIG. 2, a detailed description thereof is not repeated for the purpose of conciseness.

Thereafter, the autonomous driving guide module 13 may determine whether the inter-vehicle spacing between the autonomous vehicle 20 and the spacing-adjustment target object may be adjusted based on the user gesture input through the display 12. In an operation S300, the autonomous driving guide module 13 may transmit a control signal to the autonomous vehicle 20 to control the autonomous vehicle 20 to travel according to the inter-vehicle spacing adjusted according to the user gesture based on the determination result. Since operation S300 is the same as described with reference to FIG. 2, a detailed description thereof is not repeated for the purpose of conciseness.

When the type of the spacing-adjustment target object recognized in the operation S100 is a first type, the autonomous driving guide module 13 may store a first inter-vehicle spacing as information about an inter-vehicle spacing between the object of the first type and the autonomous vehicle 20 as input according to the user gesture in an operation S400. For example, when the object of the first type is a passenger car, and the set inter-vehicle spacing between the object of the first type and the autonomous vehicle 20 input according to the user gesture is 10 m, the autonomous driving guide module 13 may store information about the inter-vehicle spacing between the passenger car and the autonomous vehicle 20 of 10 m.

In an operation S500, when the first type of the object precedes the present vehicle as the autonomous vehicle 20 on the driving path of the autonomous vehicle 20, the autonomous driving guide module 13 may transmit a first control signal to the autonomous vehicle 20 to control the autonomous vehicle 20 to travel according to the first inter-vehicle spacing.

According to the present embodiment, the inter-vehicle spacing information based on the input using the user gesture regarding a specific type of an object may be stored. Later, the inter-vehicle spacing related to the same type of the object may be maintained according to the inter-vehicle spacing information finally set by the user. Therefore, according to the present embodiment, there is an advantage in that user convenience and user experience may be maximized in an autonomous driving situation.

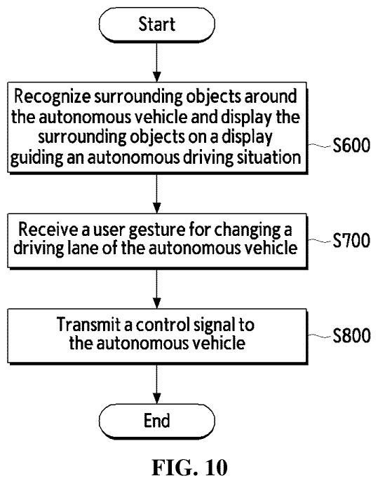

Hereinafter, a method for changing a driving lane of an autonomous vehicle based on a user gesture according to some embodiments of the present disclosure is described with reference to FIG. 10. FIG. 10 is a flowchart illustrating a method for controlling an autonomous vehicle according to some embodiments of the present disclosure.

Referring to FIG. 10, the object recognizer 11 may recognize a surrounding object around the autonomous vehicle 20, and the display 12 may display the surrounding object on a screen for guiding an autonomous driving situation in an operation S600. Since the operation S600 is the same as described with reference to FIG. 2, a detailed description thereof is not repeated for the purpose of conciseness.

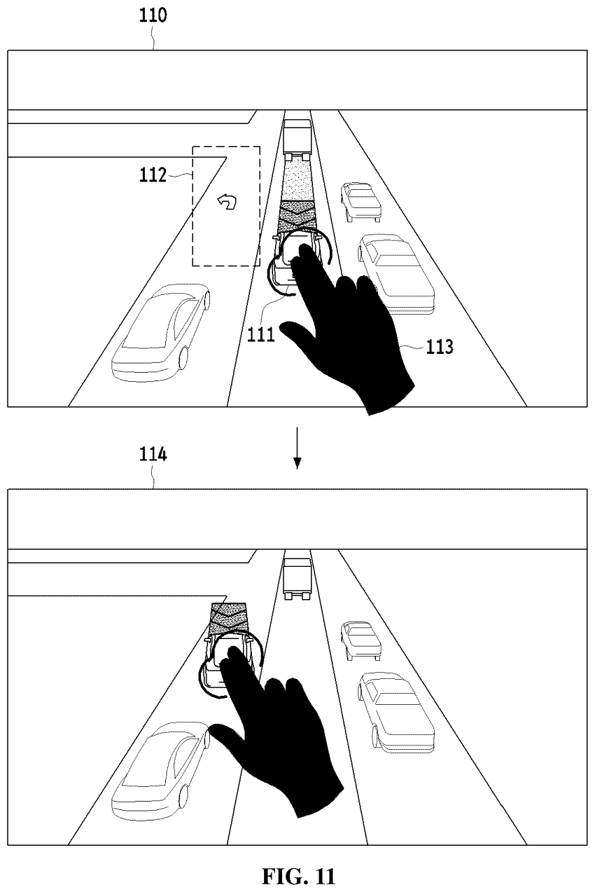

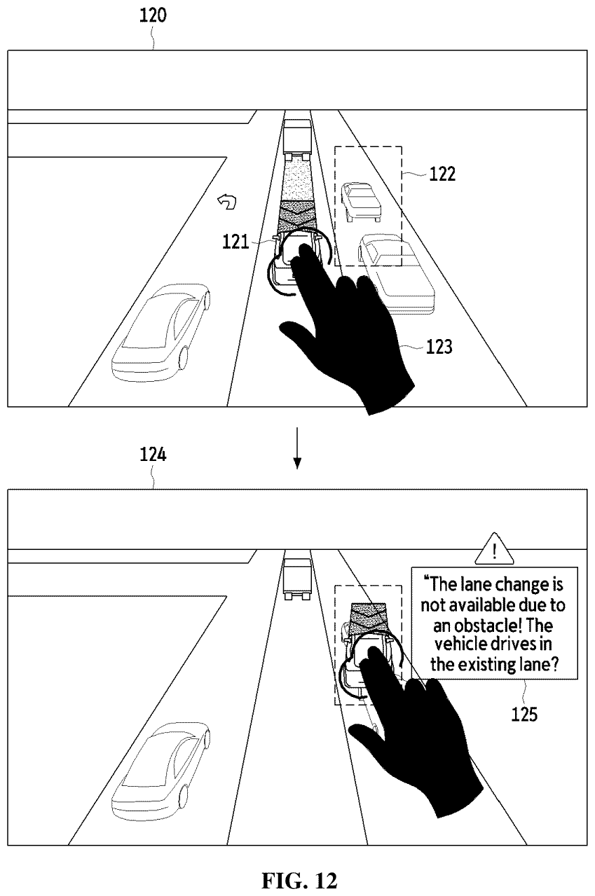

In an operation S700, the display 12 may receive a user gesture for changing the driving lane of the autonomous vehicle 20 displayed on the display. The user gesture includes a first gesture for selecting the present vehicle icon for representing the autonomous vehicle 20 on the display and a second gesture for moving the present vehicle icon to a change target lane. This is described in more detail below with reference to FIGS. 11 and 12.

In an operation S800, the autonomous driving guide module 13 may transmit a control signal to the autonomous vehicle 20 to control the autonomous vehicle 20 to travel according to the changed driving lane.

The autonomous vehicle 20 may receive the control signal from the autonomous driving guide module 13 and may drive according to the control signal.

According to the present embodiment, the user who drives the autonomous vehicle 20 may easily change a driving lane of the autonomous vehicle 20 through a user interface screen displayed on a display installed inside the autonomous vehicle 20. Therefore, according to the present embodiment, there is an advantage in that user convenience and user experience may be maximized in controlling the change of the driving lane of the autonomous vehicle.

Hereinafter, a method for changing a driving lane of an autonomous vehicle based on a user gesture according to an embodiment of the disclosure is described with reference to FIG. 11. FIG. 11 is an example diagram for illustrating a method for changing a driving lane of an autonomous vehicle based on a user gesture according to some embodiments of the present disclosure.

Referring to FIG. 11, a first user interface screen 110 before inputting of the user gesture 113 and a second user interface screen 114 after inputting of the user gesture 113 are illustrated.

Referring to the first user interface screen 110, a user who drives the autonomous vehicle 20 may select a present vehicle icon 111 representing the autonomous vehicle 20 in a first gesture 113. At a second gesture 113, the user may move the present vehicle icon 111 to a change target lane 112.

Thereafter, the autonomous driving guide module 13 may determine whether the autonomous vehicle 20 may change the current lane to the change target lane 112. Upon determination that the autonomous vehicle 20 may change the current lane to the change target lane 112, the display 12 may display, on the screen, the second user interface screen 114 in which the present vehicle icon 111 has moved to the change target lane 112.

Thereafter, the autonomous driving guide module 13 may transmit a control signal to the autonomous vehicle 20 to control the autonomous vehicle 20 to travel according to the changed driving lane 112. The autonomous vehicle 20 may receive the control signal from the autonomous driving guide module 13 and may drive according to the control signal.

Hereinafter, a method for changing a driving lane of an autonomous vehicle based on a user gesture according to some embodiments of the present disclosure is described with reference to FIG. 12. FIG. 12 is an example diagram for illustrating a method for changing a driving lane of an autonomous vehicle based on a user gesture according to some embodiments of the present disclosure.

In an embodiment, the autonomous driving guide module 13 may determine whether the autonomous vehicle may change a current lane to a change target lane. The autonomous driving guide module 13 may determine whether the autonomous vehicle may change the current lane to the change target lane based on the autonomous driving situation around the autonomous vehicle 20 obtained by the object recognizer 11. Since the determination method is already well known to a person having ordinary skill in the art to which the present disclosure belongs, a detailed description thereof has been omitted.

As a result of the determination, the autonomous vehicle 20 is unable to change the current lane to the change target lane. In this case, the display 12 may display the indication that the lane change is not available on the display in response to the user gesture. The indication that the lane change is not available may be displayed on the screen in the form of a pop-up message. However, the scope of the present disclosure is not limited thereto. The indication that the lane change is not available may be of any type as long as it may notify the user that the lane change to the change target lane is not available.

Thereafter, the autonomous driving guide module 13 may transmit the first control signal to the autonomous vehicle 20 to control the autonomous vehicle 20 to travel according to the driving lane set before receiving the user gesture.

Referring to FIG. 12, a first user interface screen 120 before inputting of the user gesture 123 and a second user interface screen 124 after inputting of the user gesture 123 are illustrated.

Referring to the first user interface screen 120, the user who drives the autonomous vehicle 20 may select a present vehicle icon 121 representing the autonomous vehicle 20 in a first gesture 123. The present disclosure is described on the assumption that the user has changed a current lane of the present vehicle icon 121 to a change target lane 122 in a second gesture 123.

In this case, since other objects or vehicles are traveling along the change target lane 122, the autonomous vehicle 20 may not change the current lane to an actual position corresponding to the change target lane 122. Accordingly, the autonomous driving guide module 13 may determine that it is impossible for the autonomous vehicle 20 to change the current lane to an actual position corresponding to the change target lane 122.

Accordingly, the display 12 may display the indication that the lane change is not available 125 on the screen in response to the user gesture 123. The indication that the lane change is not available 125 may be presented, for example, in the form of a pop-up message, and may be ‘The lane change is not available due to an obstacle! The vehicle drives in the existing lane’ together with a warning sign. In this case, the display 12 may return and display a position of the present vehicle icon 121 to a position on the display corresponding to a position on which the vehicle is currently driving.

Thereafter, together with the indication that the lane change is not available 125, the autonomous driving guide module 13 may transmit the first control signal to the autonomous vehicle 20 to control the autonomous vehicle 20 to travel according to the driving lane on which the vehicle drives before receiving the user gesture.

According to the present embodiment, the possibility of leading to a big accident in advance in a situation where it is impossible to change the current lane to the change target lane may be suppressed, such that driving stability may be improved in an autonomous driving environment

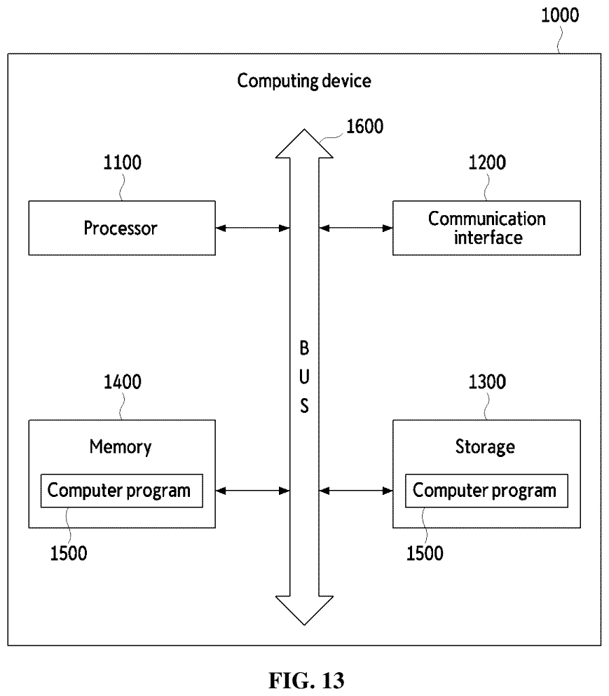

FIG. 13 is a hardware configuration diagram of a computing device according to some embodiments of the present disclosure. The computing device 1000 of FIG. 13 may include one or more processors 1100, a system bus 1600, a communication interface 1200, a memory 1400 for loading a computer program 1500 executed by the processor 1100 therein, and storage 1300 for storing the computer program 1500 therein.

The computing device 1000 of FIG. 13 may, for example, present a hardware structure of one or more computing devices constituting the autonomous driving system 10 described with reference to FIG. 1.

The processor 1100 controls overall operations of each of the components of the computing device 1000. The processor 1100 may perform an operation on at least one application or program for executing a method/operation according to various embodiments of the present disclosure. The memory 1400 stores various data, commands, and/or information therein. The memory 1400 may load one or more computer programs 1500 from the storage 1300 therein to execute methods/operations according to various embodiments of the present disclosure. The storage 1300 may non-temporarily store one or more computer programs 1500 therein.

The computer program 1500 may include one or more instructions under which methods/operations according to various embodiments of the present disclosure are implemented. When the computer program 1500 is loaded into the memory 1400, the processor 1100 may execute the one or more instructions to perform methods/operations according to various embodiments of the present disclosure.

In an embodiment, the computer program 1500 may include instructions for recognizing surrounding objects around the autonomous vehicle and displaying the surrounding object on a display guiding an autonomous driving situation; receiving a user gesture for adjusting an inter-vehicle spacing between the autonomous vehicle and a spacing-adjustment target object selected from the surrounding objects displayed on the display; and transmitting a control signal to the autonomous vehicle to control the autonomous vehicle to travel according to the adjusted inter-vehicle spacing, wherein the user gesture includes: a first gesture of selecting at least one of an spacing-adjustment target object icon representing the spacing-adjustment target object on the display and a present vehicle icon representing the autonomous vehicle on the display; and a second gesture of adjusting an inter-icon spacing using the at least one icon selected in the first gesture on the display.

So far, a variety of embodiments of the present disclosure and the effects according to embodiments thereof have been mentioned with reference to FIGS. 1-13. The effects according to the technical idea of the present disclosure are not limited to the forementioned effects, and other unmentioned effects should be more clearly understood by those having ordinary skill in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

Those having ordinary skill in the art should appreciate that many variations and modifications can be made to embodiments described herein without departing from the principles of the present disclosure. Therefore, the described embodiments of the present disclosure are used in a generic and descriptive sense only and not for purposes of limitation.

What is claimed is:

1. A method, performed by a computing system, for controlling an autonomous vehicle, the method comprising:
recognizing surrounding objects around the autonomous vehicle and displaying the surrounding objects on a display guiding an autonomous driving situation;
receiving a user gesture for adjusting an inter-vehicle spacing between the autonomous vehicle and a spacing-adjustment target object selected from the surrounding objects displayed on the display; and
transmitting a control signal to the autonomous vehicle to control the autonomous vehicle to travel according to the adjusted inter-vehicle spacing,
wherein the user gesture includes:
a first gesture of selecting at least one icon from among an spacing-adjustment target object icon representing the spacing-adjustment target object on the display and a present vehicle icon representing the autonomous vehicle on the display, and
a second gesture of adjusting an inter-icon spacing using the at least one icon selected in the first gesture on the display.

2. The method of claim 1, wherein:
the first gesture includes selecting the spacing-adjustment target object icon and the present vehicle icon; and
the second gesture includes adjusting an inter-icon spacing between the spacing-adjustment target object icon and the present vehicle icon.

3. The method of claim 1, wherein:
the spacing-adjustment target object includes an object preceding the autonomous vehicle on a driving path of the autonomous vehicle;
the first gesture includes selecting the present vehicle icon; and
the second gesture includes moving the present vehicle icon in a first direction as a same direction as a driving direction of each of the spacing-adjustment target object icon and the present vehicle icon or in a second direction opposite to the first direction.

4. The method of claim 1, wherein receiving the user gesture includes displaying an actual distance value corresponding to an appropriate inter-vehicle spacing between the spacing-adjustment target object and the autonomous vehicle on the display, wherein the appropriate inter-vehicle spacing varies based on a type of the spacing-adjustment target object.

5. The method of claim 1, wherein receiving the user gesture includes displaying an actual distance value corresponding to the adjusted inter-vehicle spacing between the spacing-adjustment target object and the autonomous vehicle on the display while the user gesture is input.

6. The method of claim 5, wherein receiving the user gesture further includes, based on determining that the actual distance value is equal to or smaller than a first distance value, displaying the spacing-adjustment target object icon, the present vehicle icon, and a line icon connecting the spacing-adjustment target object icon and the present vehicle icon to each other using a first color.

7. The method of claim 6, wherein:
receiving the user gesture includes displaying an indication that the adjusted inter-vehicle spacing is not available on the display; and
transmitting the control signal to the autonomous vehicle includes transmitting a first control signal to the autonomous vehicle to control the autonomous vehicle to travel according to an inter-vehicle spacing between the spacing-adjustment target object and the autonomous vehicle set before receiving the user gesture.

8. The method of claim 6, wherein:
receiving the user gesture includes displaying an indication that the adjusted inter-vehicle spacing is not available on the display; and
transmitting the control signal to the autonomous vehicle includes transmitting a first control signal to the autonomous vehicle to control the autonomous vehicle to travel according to a preset appropriate inter-vehicle spacing between the spacing-adjustment target object and the autonomous vehicle.

9. The method of claim 5, wherein receiving the user gesture further includes, based on determining that the actual distance value exceeds a first distance value and is equal to or smaller than a second distance value, displaying the spacing-adjustment target object icon, the present vehicle icon, and a line icon connecting the spacing-adjustment target object icon and the present vehicle icon to each other using a second color.

10. The method of claim 5, wherein receiving the user gesture further includes, based on determining that the actual distance value exceeds a second distance value, displaying the spacing-adjustment target object icon, the present vehicle icon, and a line icon connecting the spacing-adjustment target object icon and the present vehicle icon to each other using a third color.

11. The method of claim 1, wherein:
recognizing the surrounding objects around the autonomous vehicle and displaying the surrounding objects on the display guiding the autonomous driving situation includes recognizing a type of each of the surrounding objects; and
the method further comprises:
in response to determining that the type of the spacing-adjustment target object is a first type, storing a first inter-vehicle spacing as information about the inter-vehicle spacing between a surrounding object of the first type and the autonomous vehicle, wherein the information is input according to the user gesture, and
in response to determining that the surrounding object of the first type precedes the autonomous vehicle on a driving path of the autonomous vehicle, transmitting a first control signal to the autonomous vehicle to control the autonomous vehicle to travel according to the first inter-vehicle spacing.

12. A method, performed by a computing system, for controlling an autonomous vehicle, the method comprising:
recognizing surrounding objects around the autonomous vehicle and displaying the surrounding objects on a display guiding an autonomous driving situation;
receiving a user gesture for changing a current driving lane of the autonomous vehicle displayed on the display; and
transmitting a control signal to the autonomous vehicle to control the autonomous vehicle to travel according to the changed driving lane,
wherein the user gesture includes:
a first gesture of selecting a present vehicle icon representing the autonomous vehicle on the display; and
a second gesture of moving the present vehicle icon to a change target lane on the display.

13. The method of claim 12, wherein receiving the user gesture includes:
determining whether the autonomous vehicle is allowed to change the current driving lane to the change target lane; and
in response to determining that the autonomous vehicle is not allowed to change the current driving lane to the change target lane, displaying an indication that a lane change is not available on the display, in response to the user gesture,
wherein transmitting the control signal to the autonomous vehicle includes transmitting a first control signal to the autonomous vehicle to control the autonomous vehicle to travel in the current driving lane on which the autonomous vehicle drives before receiving the user gesture.

14. A system for controlling an autonomous vehicle, the system comprising:
a communication interface;
a memory configured to store a computer program; and
one or more processors configured to execute the computer program,
wherein the computer program includes computer-readable instructions that, when executed by the one or more processors, cause the one or more processors to:
recognize surrounding objects around the autonomous vehicle and display the surrounding objects on a display guiding an autonomous driving situation,
receive a user gesture for adjusting an inter-vehicle spacing between the autonomous vehicle and a spacing-adjustment target object selected from the surrounding objects displayed on the display, and
transmit a control signal to the autonomous vehicle to control the autonomous vehicle to travel according to the adjusted inter-vehicle spacing,
wherein the user gesture includes:
a first gesture of selecting at least one icon from among an spacing-adjustment target object icon representing the spacing-adjustment target object on the display and a present vehicle icon representing the autonomous vehicle on the display, and
a second gesture of adjusting an inter-icon spacing using the at least one icon selected in the first gesture on the display.

15. The system of claim 14, wherein the computer-readable instructions, when executed by the one or more processors, further cause the one or more processors to display an actual distance value corresponding to an appropriate inter-vehicle spacing between the spacing-adjustment target object and the autonomous vehicle on the display,
wherein the appropriate inter-vehicle spacing varies based on a type of the spacing-adjustment target object.

16. The system of claim 14, wherein the computer-readable instructions, when executed by the one or more processors, further cause the one or more processors to display an actual distance value corresponding to the adjusted inter-vehicle spacing between the spacing-adjustment target object and the autonomous vehicle on the display while the user gesture is input.

17. The system of claim 16, wherein the computer-readable instructions, when executed by the one or more processors, cause the one or more processors to, based on determining that the actual distance value is equal to or smaller than a first distance value, display the spacing-adjustment target object icon, the present vehicle icon, and a line icon connecting the spacing-adjustment target object icon and the present vehicle icon to each other using a first color.

18. The system of claim 16, wherein the computer-readable instructions, when executed by the one or more processors, cause the one or more processors to, based on determining that the actual distance value exceeds a first distance value and is equal to or smaller than a second distance value, display the spacing-adjustment target object icon, the present vehicle icon, and a line icon connecting the spacing-adjustment target object icon and the present vehicle icon to each other using a second color.

19. The system of claim 16, wherein the computer-readable instructions, when executed by the one or more processors, cause the one or more processors to, based on determining that the actual distance value exceeds a second distance value, display the spacing-adjustment target object icon, the present vehicle icon, and a line icon connecting the spacing-adjustment target object icon and the present vehicle icon to each other using a third color.

20. The system of claim 14, wherein the computer-readable instructions, when executed by the one or more processors, cause the one or more processors to:
recognize a type of each of the surrounding objects,
in response to determining that a type of the spacing-adjustment target object is a first type, store a first inter-vehicle spacing as information about the inter-vehicle spacing between a surrounding object of the first type and the autonomous vehicle, wherein the information is input according to the user gesture; and
in response to determining that the surrounding object of the first type precedes the autonomous vehicle on a driving path of the autonomous vehicle, transmit a first control signal to the autonomous vehicle to control the autonomous vehicle to travel according to the first inter-vehicle spacing.
